(19) United States
(12) Patent Application Publication
(10) Pub. No.: US 2021/0396499 A1
(43) Pub. Date: Dec. 23, 2021

(54) SMART SHOOTING SYSTEM BASED ON IMAGE SUBTRACTION AND KNOWLEDGE-BASED ANALYSIS ENGINE AND METHOD THEREFOR

(71) Applicant: FOCALTRON CORPORATION, Sunnyvale, CA (US)

(72) Inventors: YI-CHING PAO, LOS ALTOS HILLS, CA (US); KEVIN PURDY, HAYWARD, CA (US); JAMES PAO, LOS ALTOS HILLS, CA (US); ERIC ZHU, SAN JOSE, CA (US)

(21) Appl. No.: 17/159,704

(22) Filed: Jan. 27, 2021

Related U.S. Application Data
(60) Provisional application No. 62/969,354, filed on Feb. 3, 2020.

(51) Int. Cl. F41J 5/10; G06T 7/254; F41J 1/10; G03B 19/18; A63B 71/06

(52) U.S. Cl. CPC F41J 5/10; G06T 7/254; A63B 71/0669; G03B 19/18; F41J 1/10

(57) ABSTRACT

A target shooting tracking system has a first camera taking and recording images. An image processor receiving the images. The image processor performing image subtraction on the images to identified a latest marking on a target.

### RELATED APPLICATIONS

This patent application is related to U.S. Provisional Application No. 62/969,354 filed Feb. 3, 2020, entitled “Smart Shooting System based on Image Subtraction and Knowledge-Based Analysis Engine” in the name of the same inventors, and which is incorporated herein by reference in its entirety. The present patent application claims the benefit under 35 U.S.C § 119(e).

### TECHNICAL FIELD

The present application generally relates to motion intensive activities, and more specifically, to a system and method capable of video-capturing an object images and a player's bodily motions as well equipment movement, and tracing any relevant body parts and equipment movement to allow for pattern recognition and image processing in filtering extraneous visual information while keeping critical and useable information.

### BACKGROUND

There are situations, especially in motion intensive sports such as shooting, archery, golf, baseball, soccer, and tennis, where the movements of objects or persons are important. A player may wish to seek instant feedback regarding the behavior of any pertinent objects such as bullets, arrows, balls, rackets, and clubs, as well as to seek identification and improvement of skill deficiencies and action mistakes in the player's technique. The player may wish for feedback to correct the appropriate skills in real-time via an online cloud computing arrangement. These objectives require a localized physical platform setup that is capable of detecting and capturing all physical motions of played objects, which may travel at speeds of 10 to 2000 miles per hour, capturing the exact hitting spots on the target or targets, and predicting the objects' trajectory and motion in space.

A target-shooting system generally includes a gun or a bow that shoots a projectile at a given target pattern, such as concentric circles, at a set distance which is part of the complete assembly. When paper targets are used, the shooters typically visualize the target hit “holes” to determine the accuracy of the skill. The shooter may load the ammo or arrow and aim at a target at a set distance away with a scope at the preferred magnification. One issue which has been bothering many shooters or archers is when several shots are fired or arrows are launched. When several shots are fired or arrows are launched, it becomes difficult to track down the bullet or arrow hit sequence on the target paper as there is no convenient way to memorize and track down which bullet or arrow is corresponding to which hole. This is especially troublesome when a certain attempt of identifying the accuracy and/or consistency of different loads of ammo and gun are used. Furthermore, in some cases that if the shooters want to know the exact trajectory of a load (e.g., bullet weight versus powder type and amount) or arrow there is no easy way to do so over a long distance such as 500 to 1000 yards as an example.

There were some prior arts developed over the past 20 years to address some shooting related subjects. For example, U.S. Pat. No. 4,949,972, issued on Aug. 21, 1990 and entitled “Target Scoring and Display System”; U.S. Pat. No. 5,775,699, issued on Jul. 7, 1998 and entitled “Apparatus with Shooting Target and Method of Scoring Target-shooting”; U.S. Pat. No. 8,523,185, issued on Sep. 3, 2013 and entitled Target-shooting System and Method of Use; U.S. Patent Application Publication 2016/0121193 A1, published on May 5, 2016, and entitled “Training Devices for Trajectory-based Sports” and U.S. Pat. No. 9,360,283, issued on Jun. 7, 2016 and entitled “Shooting Range System” Jun. 7, 2016 each disclose different types of shooting systems. However, none of them address identifying and displaying the bullets or arrows hit sequence in addition to their exact hit spots on the paper target. Hence all of them fail to provide an instant analytical ability to conduct any “grouping”, “tracking”, and “improvement over shot and time” info to the shooters or archers.

These prior arts only provide either a backlighted plain camera image “as is” without any ability to trace the bullet or arrow hit sequence or require sophisticated and prearranged sensor arrays at the target range which severely limited the target system's flexibility, usefulness, and applicability.

Therefore, it would be desirable to provide a system and method that overcomes the above. The system and method are capable of providing instant feedback of all digitized bullet or arrow hit information including their Mt location and timing sequence which allows all these hit data to be either local or cloud analyzed and stored and displayed.

### SUMMARY

In accordance with one embodiment, a target shooting tracking system is disclosed. The target shooting tracking system has a first camera taking and recording images. An image processor receives the images. The image processor performs image subtraction on the images to identified a latest marking on a target.

In accordance with one embodiment, a target shooting tracking system is disclosed. The target shooting tracking system has at least one target module, wherein the at least one targe module comprises a first camera taking and recording images of a target. An image processor receiving the images, the image processor performing image subtraction on the images to identified a latest marking on the target, the image processor color codes the latest marking to highlight the latest marking.

In accordance with one embodiment, a target shooting tracking system is disclosed. The target shooting tracking system has a first camera taking and recording images of a target. A second camera recording body movement images of a user. An image processor receives the images, the image processor performing image subtraction on the images to identified a latest marking on a target, wherein the image processor color codes the latest marking. A display is used to show the target with the latest marking being color coded.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a block diagram of an exemplary embodiment of an image capturing system in accordance with an embodiment of the present invention;

FIGS. 2A-2C show an exemplary embodiment of a method to determine a last shot using the image capture system of FIG. 1 in accordance with an embodiment of the present invention;

FIGS. 3A-3C show an exemplary embodiment of a method to display and highlight a last shot using the image capture system of FIG. 1 in accordance with an embodiment of the present invention;

FIG. 4A is an exemplary embodiment of a system for trajectory tracking using the image capture system of FIG. 1 in accordance with an embodiment of the present invention; and

FIG. 4B is an exemplary embodiment of a method for trajectory tracking using the image capture system of FIG. 1 in accordance with an embodiment of the present invention.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method disclose a platform setup that may be capable of capturing a played object and a player's bodily motions as well as equipment movement. For example, for target shooting, the system and method may be capable of image-capturing a player's bodily motions such as, but not limited to, trigger pulling finger for shooting or finger releasing for archery, bullet/arrow hit location, and tracing any relevant body parts to allow for pattern recognition and image processing in filtering extraneous visual information while keeping critical and useable information. The useful information would then be collected and streamlined for efficient internet communication to the knowledge-based analysis and instruction engine, which will procure and return the appropriate cloud computing instructional feedback instantaneously.

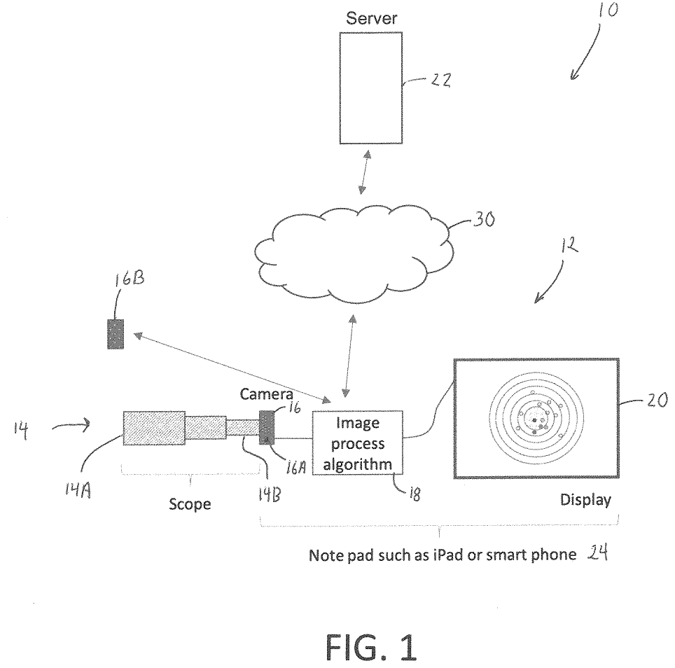

Referring to FIG. 1, a shooting target system 10 (hereinafter system 10) may be seen. The system 10 may comprises of one or more target modules 12. Each target module 12 may have a scope 14. The scope 14 may be the scope 14 located on gun of a user. The scope 14 generally has an eyepiece 14A located on one end through which the user may look through to spot a target. At the other end of the scope 14 may be the objective lens 14B. A camera 16 may be coupled to the scope 14. In the present embodiment, the camera 16 may be attached to the end of the scope 14 where the objective lens 14B may be located. The camera 16 may be used to record images of what the user is looking at through the scope 14. In accordance with one embodiment, the camera 14 may record digital images. The camera 16 may be set to take and record images at pre-set time intervals N. Alternatively, or in addition to, the camera 16 may have a sensor 16A that is used to take and record images after every shot. For example, the sensor 16A may monitor vibrations from the gun or may monitor movement of a trigger of the gun in order to determine when to take and record images.

The system 10 may have additional cameras 16B. The additional cameras 16B may be used to monitor the body movement of the user during an activity. For example, the additional cameras 16B may be capable of image-capturing a player's bodily motions such as, but not limited to, trigger pulling finger for shooting or finger releasing for archery and tracing any other relevant body part such as eye lid blinking movement associated with the activity.

A processing unit 18 may be coupled to the cameras 16 and 16B. The processing unit 18 may be used to analyze the images recorded by the cameras 16 and 16B. In accordance with one embodiment, the processing unit 18 may compare images before a shot is fired and after a shot is fired from a gun upon which the scope 14 may be mounted. The processing unit 18 may use an image subtraction algorithm and either display the resulting outcome image on a screen 20. Alternatively, or in addition to, the processing unit 18 may transmit the outcome image to a remote server 22 for storekeeping, storage, and analysis. Each target module 12 may be deploy either in a standalone way or sequentially and collaboratively for trajectory tracing and calculation purposes as will be disclosed below. In accordance with one embodiment, the processing unit 18 and the screen 20 may be part of a portable computing unit 24. The portable computing unit 24 may be a smart phone, a tablet, a laptop or similar type of device.

In operation, the user attaches the camera 16 to the scope 14. The user may use the scope 14 to view a target image, at a given distance, as well as the hit hole created by the bullets or arrows. The cameras 16 and 16B may record images at a predetermined timeframe N. Upon taking a shot at the target image, the processing unit 18 may compare an image before the shot is fired (Time N) to an image after the shot is fired (Time N+1) and to generate an outcome image. The outcome image may be used to identify the last shot location. Additional information may be provided such as data to show the progression of shots, a time stamp of shot information and the like. The outcome image may be shown on the display 20 such as a smartphone, tablet, or other similar portable computing device 24.

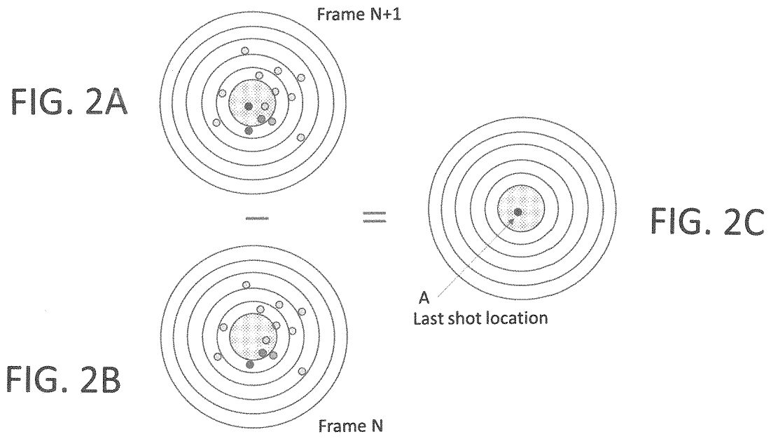

Referring now to FIGS. 1 and 2A-2C, a method of operation of the image subtraction algorithm used by the processing unit 18 may be disclosed. The camera 16 may be designed to take an image repeatedly by a given time interval N as shown in FIG. 2B. When at interval N+1, the camera 16 takes a new target image as shown in FIG. 2A. The processing unit 18 may be used to identify the final shot location and mark it digitally. The image subtraction algorithm stored in the processing unit 18 may subtract the store image at time interval N from the store image at time interval N+1. The image subtraction algorithm may accomplish this by performing a pixel-by-pixel analysis of the store image at time interval N and the store image at time interval N+1. If there is a new bullet hole that happened between intervals N and N+1, then the image subtraction algorithm may identify and pinpoint any new bullet hole or holes as marked “A” in the outcome image shown in FIG. 2C. Thus, the last shot location and other identifying information, such as a time stamp, can then be identified and labeled.

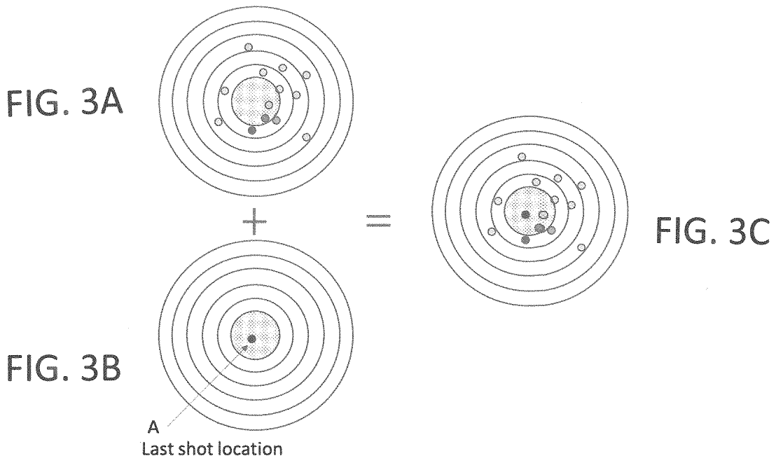

Referring now to FIG. 3A-3C, once the new bullet hole or holes are identified and digitally marked through the image subtraction algorithm as shown in FIG. 2C, the new hole location(s) (FIG. 3B) may then be added back to the original image at time N (FIG. 3A) to form a resulting image (FIG. 3C). The resulting image may have the holes color coded. The color coding may help to identify the timing of each shot. For example, the latest hole of “A” (FIG. 3B) may be given the brightest “red” color code. The brightness level may fade based on when the hole was formed. For example, the latest hole may be given the brightest color, while the earliest hole may be given the dullest color. Thus, the color of the holes may progressively fade from brightest color for the newest hole to the dullest color for the earliest hole.

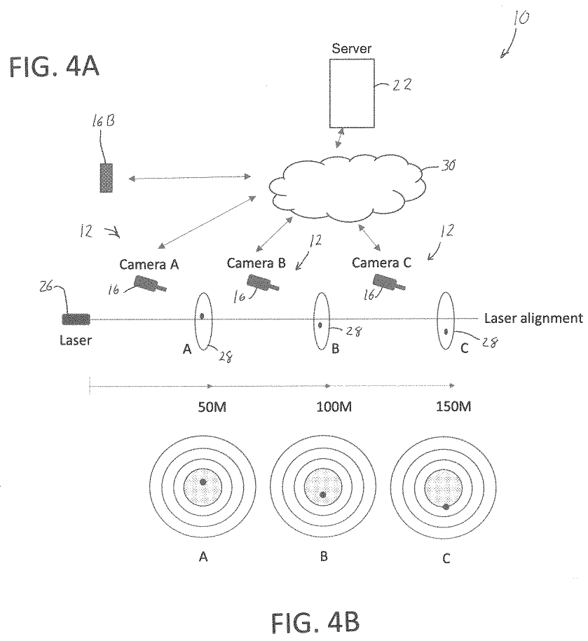

Referring to FIG. 4A, the system 10 may be used in shooting applications to measure the actual bullet “trajectory” in space instantly. In FIG. 4A, the system 10 may use a plurality of target modules 12 to measure the actual bullet “trajectory”. While, three (3) target modules 12 may be shown, more or less target modules 12 may be used.

Referring now to FIG. 4A-4B, a method for indicating the exact trajectory of a load using the system 10 may be disclosed. A series of individual target modules 12 may be placed at given distances in space and aligned linearly through a laser beam 26 as shown in FIG. 4A. A camera 16 of each target module 12 may be positioned in front of a respective target 28 of the target module 12. When a shot is fired, the bullet may create a series of corresponding “holes” when it passes through each of the series of laser aligned target modules 12. The holes marked on each target 28 may represent the real bullet flight trajectory through space. As each target module 12 renders the exact locations of the holes through space, and collaboratively the trajectory of the shot can be mapped in 3D and recreated on a PC and displayed based on the inputs of each target module 12 in an instant way.

Embodiments of the exemplary system and method may allow the user to track down a bullet or arrow hit sequence on a target as there is no convenient way to memorize and track down which bullet or arrow is corresponding to which hole. The present system and method are fundamentally different in any aspect from the prior arts.

For example, U.S. Pat. No. 5,775,699, entitled “Apparatus with Shooting Target and Method of Scoring Target-shooting” does not use digital image subtraction to track the time sequence of the bullet hits. Instead, this prior art uses a mirror and light to bounce light towards the backside of the target, which means that light only passes through wherever the bullet was shot. The image of light through the target is captured by the camera and used to identify the location of all shots that are on the target. When more than one bullet or arrow is shot, one cannot identify the order and or the sequence of the shots and the repeated pictures given to the user have no sequential timing or ordering information on which bullets hit at what time.

Since all data and images may be captured and digitized, the exemplary system 10 and method may be connected through a wireless network 24. Thus, the images captured by the cameras 16 and 16B may be sent through a wireless network 30 to a cloud-based analysis engine hosted on one or more servers 22. The cloud-based analysis engine may consist of both specific algorithms and comparison databases, which may utilize existing internet infrastructure and channel to host a library of analyzed feedback information. The additional camera 16B can also be used to pin point the shooter's or archer's motions of stance, arm movement, and finger pulling/releasing actions, even eye lid blinking motions and tie those images to the shoot data captured by the target module 12. In this case each shooter or archer can track their skilled movements of their body parts to the individual shoot data captured by the target module 12, providing the shot plus body image data set for any knowledge based analyze engine to record, track, analyze, categorize, and summarize the dataset in order to provide instructional and skill improvement suggestions over instant online cloud-based computation.

This instant feedback information can range from text-based instruction, audio-based, graphics and images, and even video clip instruction. This instructional feedback information may be organized in a manner that may allow the analysis engine to consider any technique flaws and determine appropriate corrective actions and suggestions. These instructive and corrective actions may be categorized and be extracted from the database and presented to the user instantly. By placing this feedback information on a cloud-based database the information can be constantly updated, improved, and expanded to allow for more relevant feedback that may be accessed quickly by multiple worldwide users. This instant feedback on-demand process, much like most internet web pages, may be loaded only when necessary, meaning the memory needed at the local platform such as smartphone or note pad may be minimal. If all information is stored locally, then outdated feedback information must be constantly tracked, updated, and even deleted. This is to prevent the new information from being constantly downloaded for local storage, leading to inefficiency and poor memory usage and resource management. This highly efficient cloud-based feedback on-demand infrastructure of knowledge-based analysis engine and its associated database will be very important, as it will serve as the link between the input of the captured shot and trajectory data with any relevant body movement images, and the appropriate analyzed instruction feedback and output to be provided to the shooters or archers.

The foregoing description is illustrative of particular embodiments of the application, but is not meant to be a limitation upon the practice thereof. The following claims, including all equivalents thereof, are intended to define the scope of the application.

What is claimed is:

1. A target shooting tracking system, comprising:
a first camera taking and recording images; and
an image processor receiving the images, the image processor performing image subtraction on the images to identified a latest marking on a target.

2. The target shooting tracking system of claim 1, wherein the image processor color codes all markings.

3. The target shooting tracking system of claim 1, wherein the image processor color codes all markings indicating a timing of each marking, wherein a newest marking is a brightest color.

4. The target shooting tracking system of claim 1, comprising a display to show a final target.

5. The target shooting tracking system of claim 4, wherein the display is part of a portable computing device.

6. The target shooting tracking system of claim 1, comprising a display to show a final target, wherein the image processor color codes all markings on the final target indicating a timing of each marking.

7. The target shooting tracking system of claim 1, comprising a scope, the camera coupled to a lens end of the scope.

8. The target shooting tracking system of claim 1, comprising a second camera recording body movement images of a user.

9. The target shooting tracking system of claim 8, comprising a server receiving the images from the first camera and body movement images of the user for analysis and providing feedback to adjust body position.

10. A target shooting tracking system, comprising:
at least one target module, wherein the at least one target module comprises:
a first camera taking and recording images of a target; and
an image processor receiving the images, the image processor performing image subtraction on the images to identified a latest marking on the target, the image processor color codes the latest marking to highlight the latest marking.

11. The target shooting tracking system of claim 10, comprising a plurality of target modules, wherein each of the plurality of target modules are aligned linearly.

12. The target shooting tracking system of claim 11, comprising a laser to linearly align each of the plurality of target modules.

13. The target shooting tracking system of claim 11, wherein the image processor receives images from each of the plurality of target modules and generates a trajectory of a projectile.

14. The target shooting tracking system of claim 13, comprising a display to show the latest marking on the target and the trajectory of the projectile.

15. The target shooting tracking system of claim 11, comprising a second camera recording body movement images of a user.

16. The target shooting tracking system of claim 15, comprising a server receiving the images from the first camera and body movement images of the user for analysis and providing feedback to adjust body position.

17. A target shooting tracking system, comprising:
a first camera taking and recording images of a target;
a second camera recording body movement images of a user;
an image processor receiving the images, the image processor performing image subtraction on the images to identified a latest marking on a target, wherein the image processor color codes the latest marking.
a display to show the target with the latest marking being color coded.

18. The target shooting tracking system of claim 17, comprising a scope, the first camera coupled to a lens end of the scope.

19. The target shooting tracking system of claim 17, comprising a server receiving the images from the first camera and body movement images of the user for analysis and providing feedback to adjust body position.

20. The target shooting tracking system of claim 19, wherein the server receives the images from the first camera and body movement images of the user wirelessly over a network.
